(19) United States
(12) Patent Application Publication
(10) Pub. No.: US 2012/0113051 A1
(43) Pub. Date: May 10, 2012

(54) TOUCH- OR PROXIMITY -SENSITIVE INTERFACE

(75) Inventors: Neil Christopher Bird, Cambridgeshire (GB); John Richard Alan Ayres, Reigate (GB)

(73) Assignee: KONINKLIJKE PHILIPS ELECTRONICS N.V., EINDHOVEN (NL)

(21) Appl. No.: 13/322,785

(22) PCT Filed: May 18, 2010
(86) PCT No.: PCT/IB2010/052202

§ 371 Date: Jan. 26, 2012

(30) Foreign Application Priority Data
May 27, 2009 (EP) 09305484.9

(51) Int. Cl. G06F 3/044; G06F 3/041

(52) U.S. Cl. 345/174; 345/173

(57) ABSTRACT

The invention relates to a device, comprising a touch- or proximity-sensitive interface, the interface comprising a sensor electrode arrangement configured to receive one or more body-coupled communication signals via a user part touching or approaching the interface, and a detector configured to detect a position of the user part based on the one or more body-coupled communication signals. Embodiments provide an interactive surface which comprises a sensor electrode arrangement for detecting a position of a finger or other part touching, or approaching, the interactive surface. Body-coupled communication signals received by means of the sense electrode arrangement are evaluated for increasing the sensitivity of position detection.

### FIELD OF THE INVENTION

The present invention relates to the field of touch- or proximity-sensitive interfaces and more specifically to an interface configured to detect a position of touching or approaching the interface. Further, the invention relates to a respective method and computer program product.

### BACKGROUND OF THE INVENTION

U.S. Pat. No. 5,796,827 discloses a system for near-field encrypted communication using human-body coupling. A transmitter worn by a person generates electric signals transmitted through the human body to receiver electrodes touched by a finger of the person. An authenticator connected to the receiver processes received encoded data and validates the authenticity of the transmission.

Generally, a transmission of electrical signals generated by a transmitter to a receiver using a human body is also called body-coupled communication, BCC.

### SUMMARY OF THE INVENTION

In accordance with an embodiment of the invention, a device is provided which comprises a touch- or proximity-sensitive interface such as a touch screen as an example. The interface comprises a sensor electrode arrangement which is configured to detect a position of a user part touching or approaching the interface. The user part may for example be a human finger, or may e.g. be an at least partially electrically conductive device such as a conductive pin or stylus held by a human person. Further, preferably a receiver is provided configured to receive one or more body-coupled communication signals. These signals may be transmitted via a human body of a person using the device. In this embodiment, the position of the user part such as a finger pointing to or touching e.g. a touch screen of the device can be detected with high reliability, e.g. when employing capacitive sensing technique.

In accordance with one or more of the embodiments, a device comprises a touch- or proximity-sensitive interface, the interface comprising a sensor electrode arrangement configured to receive one or more body-coupled communication signals via a user part touching or approaching the interface, and a detector configured to detect a position of the user part, or other information such as a code, based on the one or more body-coupled communication signals.

The sensor electrode arrangement may be a capacitive sensing arrangement incorporated inside the interface, allowing a contact-free sensing and a protection of the sensing components.

The sensor electrode arrangement may comprise a first set of at least two, three or more sense electrodes and a second set of at least two, three or more sense electrodes, the first set of sense electrodes being angularly arranged to the second set of sense electrodes. Such an arrangement allows high positional resolution.

The device may comprise at least one of an active plate, a passive plate, and a matrix of sense electrodes added to at least one of the plates. A liquid crystal may be arranged between the active plate and the passive plate. A compact structure is provided.

The sensor electrode arrangement may comprise sense electrodes, optionally arranged in form of a grid or an X-Y configuration, at least one sense amplifier, and switches for connecting the sense electrodes to the at least one sense amplifier. This matrix arrangement allows quick scanning of the electrodes and compact reliable structure.

The interface may comprise at least one of a touch sensitive display, a touch screen, a liquid crystal display, a proximity sensitive display, and an interactive surface.

The device may comprise a correlator configured to correlate a received body-coupled communication signal received via the user part with a communication signal transmitted to a user body. Such correlation provides accurate detection.

The receiver may be configured to receive a coded signal coupled to a user body. The device may comprise means configured to provide an identification function, the identification function configured to identify a user by means of a coded signal received via the sensor electrode arrangement. Therefore, high security may be ensured. The device may comprise means configured to provide a security function, the security function configured to identify a user by means of a coded signal received via the sensor electrode arrangement, the security function being configured to at least one of restrict access to the device depending on the identification result, customise a user interface, enable/disable certain functions for different users, personalise devices such as light switches.

In accordance with one or more embodiments the device may comprise an integrated or separate transmitter configured to transmit communication signals to the body of a user of the device, allowing effective coupling of the BCC signals.

The device may be or comprise a liquid crystal device, a handheld device, a mobile phone, a remote control, or an equipment controller.

In accordance with one or more embodiments, a method comprises
receiving one or more body-coupled communication signals via a sensor electrode arrangement of a touch- or proximity-sensitive interface, and
detecting an information, or a position of a user part touching or approaching the interface, based on the one or more body-coupled communication signals received via the user part and the sensor electrode arrangement.

In accordance with one or more embodiments, a computer program or computer program product may comprise software code portions for receiving one or more body-coupled communication signals via a sensor electrode arrangement of a touch- or proximity-sensitive interface, and detecting a position of a user part touching or approaching the interface, or other information, based on the one or more body-coupled communication signals received via the user part and the sensor electrode arrangement.

The program may e.g. be stored on a computer-readable medium.

These and other aspects of the invention will become apparent from and elucidated by the embodiments described hereinafter.

### BRIEF DESCRIPTION OF THE DRAWINGS

FIG. 1, consisting of FIGS. 1a, 1b, 1c, illustrates a basic structure of a display and shows enlarged details of examples of plate structures;

FIG. 2 illustrates a principle of body-coupled communication usable in one or more embodiments of the invention;

FIG. 3 shows an embodiment of a hand-held device in accordance with the invention;

FIG. 4 illustrates an embodiment of a sensor electrode arrangement and related circuitry;

FIG. 5 shows an embodiment comprising a hand-held device and an additional portable device physically separated from the hand-held device;

FIG. 6 shows an embodiment of an arrangement of sensor electrodes and related circuitry usable e.g. for the embodiment of FIG. 5; and

FIG. 7 illustrates a flow diagram of an embodiment of a method in accordance with the invention.

### DETAILED DESCRIPTION OF EMBODIMENTS

Displays incorporating a touch interface may be used for a broad range of applications such as e.g. for or inside a variety of consumer hand-held devices such as mobile phones, remote controls, computer devices, etc. The term touch interface as used here is intended to encompass a touch-sensitive interface responding to a direct touch by means of e.g. a finger of a human person such as a user, or by any kind of tool such as a conductive pencil held by, or attached to, a user. Further, the term touch interface also encompasses any proximity-sensitive type of interface which is configured to detect the presence and/or position of a human body part such as a finger or other part, or any other type of tool already when approaching to the display or interface even in case some distance such as e.g. 10 to 20 mm still exists between the tip of the finger or tool and the interface surface.

Touch displays may also be used for the control of equipment e.g. in hospitals or other types of contamination-critical locations where keyboards may not be a preferred solution because of difficulties of cleaning the keyboards, in order to avoid the possibility of contamination and the like.

In one or more embodiments of the present invention, a touchless interaction may be provided wherein capacitance changes caused by the proximity of a finger or other tool to the display may be used to locate the position of the finger or other type of body part or tool. In addition, the touch functionality may also be used for recognizing gestures such as drawing of circles or speed and/or direction of movement. The capacitance changes may be measured using electrodes situated e.g. around the edge of the display. In one or more embodiments, the touch function is or may be integrated into the display such as a liquid crystal display, LCD, itself. Integration of the touch function into the display or any other type of device itself is able to reduce the thickness of the display or other type of device as well as costs. Further, there is no need for additional driving electronics. The touch position can be detected in a capacitive manner where e.g. capacitance changes caused by the presence of e.g. a finger or tool may be measured via an array or a grid of electrodes such as row and column electrodes or x/y electrodes. In another embodiment, a resistive implementation may be used where a touching finger or tool causes two resistive layers or strip line electrodes to connect or short together at the touching position, and resistances, or resistance differences to the edges or corners of the display may be measured for position detection.

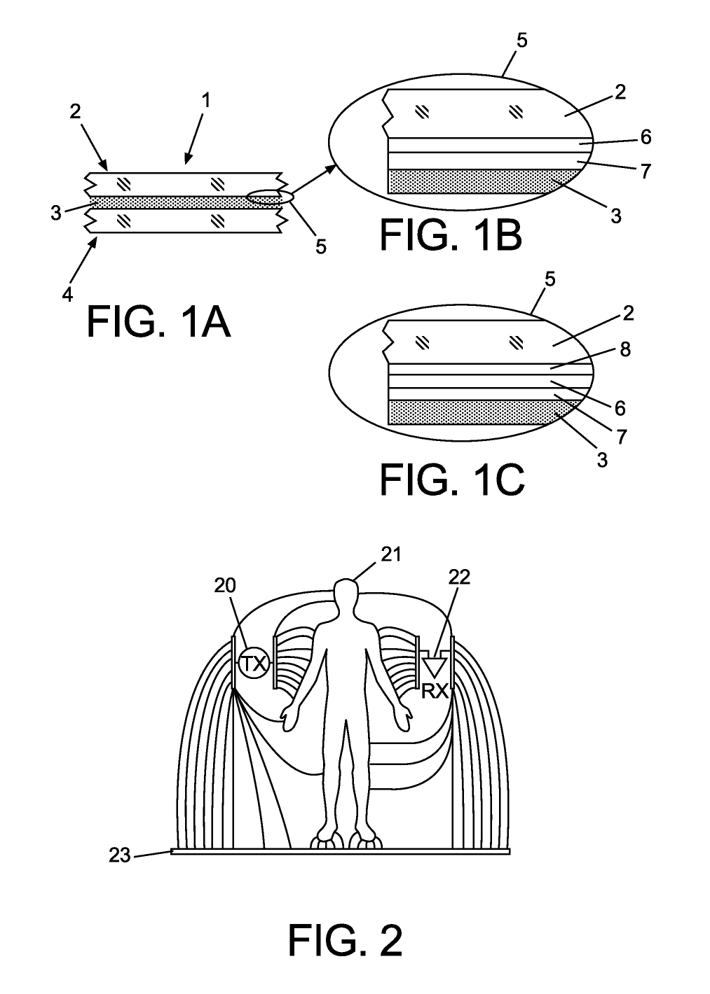

FIGS. 1a, 1b and 1c show a diagrammatic representation of an LCD device 1. FIG. 1a illustrates a basic LCD structure wherein the device 1 comprises a passive plate 2 and an active plate 4 sandwiching a liquid crystal layer 3 in between.

A detail 5 of FIG. 1a is shown in more detail in FIG. 1b. A color filter 6 and a common electrode 7 are arranged between the passive plate 2 and the liquid crystal layer 3. The color filter provides desired coloring of a displayed information. The common electrode 7 provides reference potential for driving circuitry provided to the active plate 4 so as to drive pixels of the LCD display 1 in a desired manner with high precision.

The implementation of FIG. 1c is effective in adding touch functionality to the display 1 by providing additional sense electrodes 8 to the display. In the embodiment of FIG. 1c according to an implementation of the invention, the sense electrodes 8 are sandwiched between the passive plate 2 and the color filter 6 on top of the common electrode 7. The sense electrodes 8 may in another embodiment also be provided at another layer or position. The arrangement of FIG. 1c provides compact structure with effective protection of the sense electrodes 8 against damages caused e.g. by a finger or tool touching the LCD display 1. The color filter 6 provides, in addition to the coloring function, an insulation between the sense electrodes 8 and the common electrode 7.

In the embodiments of FIGS. 1a to 1c, the active plate 4 of the LCD 1 comprises electronics such as e.g. pixel transistors and row/column drivers or other types of matrix drivers. The active plate 4 may be made of, or comprise, thin films of silicon (Si) such as amorphous Si or poly-Si. The passive plate 2 comprises or carries the common electrode 7, which may be a grounded electrode, and the one or more color filters 6. As shown in FIG. 1c, the touch function is incorporated by adding a matrix of row and column electrodes, acting as the sense electrodes 8, to the passive plate structure. In the embodiment of FIG. 1c, the electrodes 8 are incorporated in the display, with the passive plate 2 being located between a finger or other part of the human body or tool, and the electrodes 8.

In the embodiment of FIG. 1c, the position of a finger or other part of human body or tool etc. may be determined by measuring changes in capacitance, caused by the presence of the finger or tool, between adjacent row and column electrodes 8.

In one or more embodiments of the invention, the sensitivity of the detection mechanism using e.g. the embodiment of FIG. 1c may be increased by using a technique called body coupled communication, BCC.

Embodiments of the invention ensure sufficiently high sensitivity of the capacitive sensing mechanism and ensure reliable operation even when incorporating the electrodes 8 for the capacitive touch sensing function into the display, instead of having for example a separate overlay on top of the display.

In spite of the presence of the passive display plate 2 between the sensing electrodes 8 and a touching finger, leading to reduced changes of capacitance between electrode and finger or other (conducting) pointing device, and/or the proximity of the common electrode 7 introducing a large capacitance between the sensing electrodes 8 and ground, the touch sensing mechanism according to one or more or all embodiments of the invention provides high accuracy and reliability and therefore high sensitivity. Employing body coupled communication into the display, interface, or other type of input and/or output device, is effective in increasing the sensitivity of the capacitive sensing mechanism.

In addition, or in another embodiment of the invention, use of body coupled communication provides a mechanism for the application, e.g. to selectively allow/disallow a given user to use certain functions of the application or to use the whole device, etc.

FIG. 2 shows a schematic illustration of the principle of body-coupled communication, BCC. Communication is effected by having a transmitter device 20 attached to the body 21 of a human person. The transmitter device 20 may also be provided separate from the body 21 and may be touched by a body part, or may be arranged proximate to, and capacitively coupled to, the body 21. A receiver 22 is configured to receive signals generated by the transmitter 20 and transmitted via the body 21 to the receiver 22. The receiver device 22 may be attached to the body 21, or may be touched by or approximated by a part of the body 21 such as a finger so as to be capacitively coupled to the body in case of proximity or touch.

Signals generated by the transmitter device 20 shown at the left-hand side of body 21 in the drawing of FIG. 2, are capacitively coupled to the body 21. The receiver 22 device shown at the right-hand side of body 21 detects these signals generated by the transmitter 20 and transmitted via the body 21. Since the signals propagate over the body 21 and are not substantially radiated away from the body 21, communication is only possible in close proximity to the body 21. Therefore, there is very little interference between adjacent body coupled communication networks such as networks on other persons. Further, this concept provides advantages for security and ease of set-up for body sensor systems.

At least one, more or optionally all embodiments may be adapted to use the body-coupled communication mechanism to increase the sensitivity of the touch sensing mechanism. Even in case the proximity of the common electrode 7 to the sensing electrodes 8 should introduce a large capacitance between the sensing electrodes 8 and ground in some applications, possibly presenting difficulties in measuring small capacitance changes and in coupling noise to the sense electrode electronics, the sensitivity of embodiments described herein is high, allowing high accuracy and reliability of the touch sensing mechanism, essentially unaffected by the presence of the display passive plate 2 between the sensing electrodes 8 and the touching or approximating human part such as a finger.

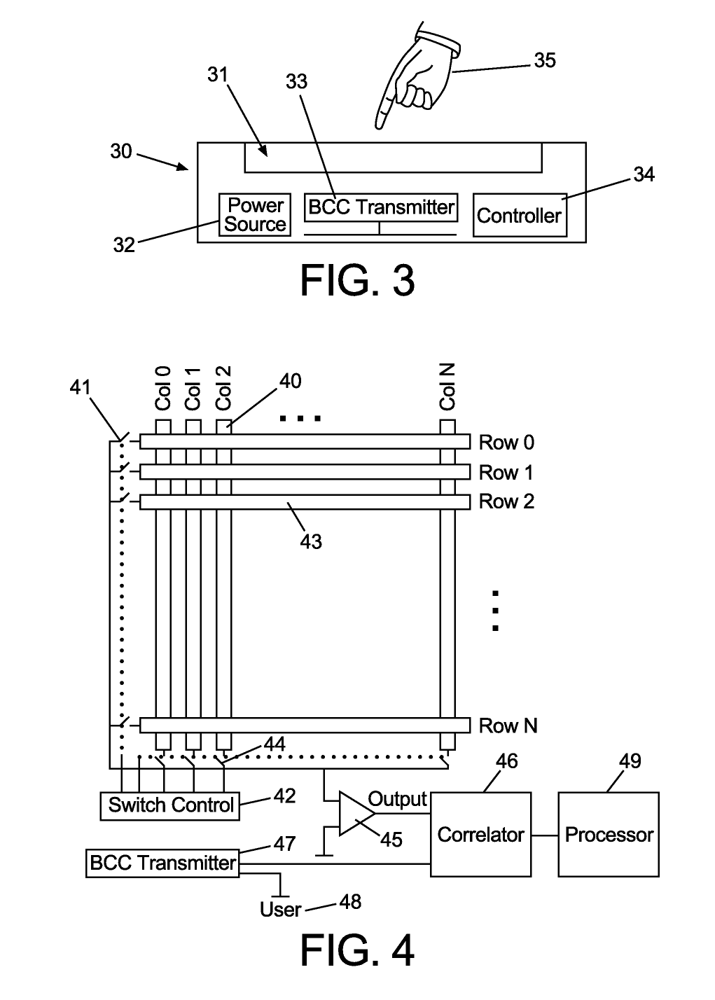

FIG. 3 illustrates an embodiment implemented as hand-held device 30 such as for instance a personal digital assistant, PDA, mobile phone, portable laptop or netbook, remote controller, etc.

The device 30 comprises a touch-sensitive display 31, a power source 32, a body-coupled communication, BCC, transmitter 33 capacitively coupled to a user, and a controller 34. In operation, a user may hold the device 30 in one hand, e.g. the left hand so as to be capacitively coupled to the BCC transmitter 33, and may point to the display 31 with a finger 35 of the other hand.

The power source 32 provides power supply to the device 30 and may for example be implemented as a battery, charge accumulator etc. The controller 34 is configured to control at least part or all of the functions of the device 30 such as the display content, detection of a touching or approaching finger 35, actuation of keys or soft buttons and/or input and output of other operating instructions. The display 31 may display several separate areas such as soft buttons having different functions and/or names displayed on the display 31 so as to be alternatively, or combinedly, selectable.

The BCC transmitter 33 may be provided at an underside of the device 30 or any other appropriate position for coupling a signal onto the user's body which signal then propagates over the surface of the body, see body 21 of FIG. 2 for example, including the finger 35 used for pointing to a desired location or position on the touch-sensitive display 31.

When the user is pointing to the display 31, the BCC signals generated by the transmitter 33 will then be detected by the sense electrodes 8, see FIG. 1c, in the display 31. The sense electrodes 8 may be arranged in a matrix fashion such as row and column sense electrodes, with several row column electrodes running parallel to each other, and the column sense electrodes running parallel to each other but at an angle to the row sense electrodes. The angle may have a value of 90°, with the row and column electrodes running perpendicularly to each other, or may also have a value different from 90°, for example 45° or any other appropriate value between 0° and 180°.

In the embodiment of FIG. 3, and optionally also in other embodiments described herein after, rather than detecting changes in capacitances for determining the location of the body part such as a finger, the device or system may now detect the signal that is being generated by the BCC transmitter 33. In a further implementation, the system may detect the signal generated by the BCC transmitter 33 as sensed by the sense electrodes, e.g. electrodes 8 of FIG. 1c, and may additionally, or exclusively, detect changes in capacitances to determine the location of the finger or other body part or tool for detecting the position to which the finger or other tool is pointing.

If the finger 35 or other part or tool is in close proximity to the touch-sensitive display 31 and the screen thereof, for example within one centimeter or more or less of the display surface, the BCC signal can already be detected via the sense electrodes 8. Therefore, the user does not need to physically touch the desired position on the display surface showing the desired symbol, function, label or the like. A touch can be defined to have occurred when the magnitude of the received signal increases above a threshold level, which may be at a point where the finger is not physically touching the surface. This proximity detection may advantageously be used by the user for changing more rapidly the pointing positions and thus the selection of commands or selections when successively pointing to different parts of the display for inputting a sequence of input commands or selections.

The signals transmitted by the BCC transmitter 33 may e.g. be used to increase sensitivity of the touch sensing mechanism in the following manner. A specific code such as a digital code may be repeatedly transmitted by the BCC transmitter 33 to the body. In the receive electronics, a correlator-based approach may be used in one or more embodiments such as the embodiments described above or below, for detecting this transmitted code. This approach provides a further improvement of the sensitivity. Use of a correlator-based detection mechanism is able to provide an improvement of the signal-to-noise ratio, S/N ratio, of up to e.g. 20 dB.

In the embodiment shown in FIG. 3, the body-coupled communication operates using capacitive coupling. The BCC transmitter 33 provided at the underside of the hand-held device may be completely encapsulated in a casing of the device 30 and does not need to have a galvanic connection to the user. As shown in FIG. 3, the BCC transmitter 33 is provided inside the casing of device 30, and transmits the BCC signals by capacitive coupling to the user holding the device 30. In one or more embodiments, the transmit electrode of transmitter 33 illustrated by the line running parallel to the bottom casing and connected to transmitter 33 can be arranged on the inner surface of the casing of the device. The casing may consist of plastic material or other suitable material allowing effective transmission of the BCC signals to the user's body by capacitive coupling, as described above.

FIG. 4 shows a structure or arrangement of the sense electrodes or detection electrodes 8 which may be incorporated in the passive plate, e.g. plate 2 of FIG. 1c, of the display 31. In the embodiment of FIG. 4, the sense electrodes 40, 43 are arranged in a matrix-like fashion such as an X-Y configuration. The sense electrodes 40, 43 comprise a plurality of parallel column electrodes Col0 to COlN, and a plurality of parallel row electrodes Row0 to RowN. The column and row electrodes 40, 43 are arranged at equal distances in the embodiment of FIG. 4. The cross-points between the column electrodes 40 and the row electrodes 43 provide a dense pattern of position detecting grid points, allowing detection of a pointing position of e.g. of the finger of hand 35 of FIG. 3 with high positional resolution. Therefore, the touch-sensitive display 31 may be arranged to present or show a plurality of adjacent selection fields arranged e.g. in X- and Y-directions. A desired selection field can then be selected by a user with high precision by approaching, or touching, a desired field which e.g. displays a desired selection button, function, information or the like.

As shown in FIG. 4, each of the row electrodes 43 is connected to a respective switch 41 of a series of switches 41. A switch control 42 provides timing control of closing and opening of the switches 41 in a successive manner so as to connect one of the row electrodes to the input of a sense amplifier 45 in a successive manner.

In a similar manner, a plurality of switches 44 are connected to the column electrodes 40 so as to successively select one of the column electrodes 40 for connection to the input of sense amplifier 45. The switch control 42 is configured to control the switching of the switches 44 at an appropriate timing coordinated with the switching on and off of the switches 41. The other input of sense amplifier 45 may be connected to ground or other reference potential. In the embodiment of FIG. 4, only one sense amplifier 45 is provided which is connected to the series of switches 41, 44. In other embodiments, two or more sense amplifiers may be provided, allowing for example a further increase of the scanning speed of the sense electrodes by forming subgroups of electrodes being read in parallel.

FIG. 4 shows a BCC transmitter 47 which is configured to generate the BCC signals coupled to the body of the user, as illustrated by reference numeral 48. The BCC transmitter 47 may e.g. correspond to the transmitter 33 shown in FIG. 3.

A signal of BCC transmitter 47 is not only capacitively coupled to the user 48, but is directly applied to an input of a correlator 46. An output from the BCC transmitter 47 is connected to the user, e.g. to the buffer driving transmitter electrode. A second output from the BCC transmitter 47 is connected to the correlator 46. The signals to the correlator and the user, e.g. the transmitter electrode, have the same timing sequence but may in one or some embodiments be separately buffered and may also be in one or some embodiments of different magnitude. The other input of the correlator 46 is connected to an output of the sense amplifier 45. The correlator 46 output is connected to an input of a processor 49 for evaluating the correlated signals and detecting a pointing position, selected display field, desired command etc., code etc.

In the following, an example of operation of the embodiment of FIGS. 3, 4 is explained. A first of the electrodes 40, 43 (row or column), e.g. electrode Row0, is connected to the input of sense amplifier 45 by switching on the respective switch 41 connected to that electrode Row0, under control by the switch control 42. The above process is repeated for each sense electrode, both in row and column directions, wherein optionally only one sense electrode at a time is connected to the input of sense amplifier 45, successively scanning all electrodes 40, 43 by appropriately controlling the switching on and off of the switches 41, 44.

The BCC transmitter 47 sends out a transmitter signal, for example a digital code, for instance continuously or on an intermittent basis. The BCC transmitter 47 may be powered by a power source of the device, e.g. by power source 32 of FIG. 3 when switching the device 30 on, and terminating power supply to the BCC transmitter 33, or 47 of FIG. 3 when switching the power source 32, and thus the device 30 off.

The transmitter signal such as the digital code, generated by the BCC transmitter 33, 47 is transferred over the body of the user 48 and can then be detected by the sense amplifier 45, e.g. when a finger 35 of user 48 is pointing at the display 31 close to the electrode, e.g. Row0, currently connected to the amplifier 45.

The output of the sense amplifier 45 is connected to an input of an evaluation or detection circuit such as e.g. the correlator 46.

As shown in FIG. 4, the other input of correlator 46 is connected to the BCC transmitter 47 generating the BCC signal coupled to the user 48. The signal from the finger 35, or any other body part or tool touched by the user 48, can then be detected with much increased sensitivity, compared to a mechanism of measuring how the presence of the finger or other body part or tool perturbs an inter-electrode capacitance.

Additionally, or in one or more other embodiments, the number of sense amplifiers 45 may be increased to two or more, providing a detection of signals from more than one sense electrode in parallel, providing an increase of the scanning speed. In such an embodiment, the row and column electrodes of the electrodes 40, 43 may be formed into groups. As an example, all row electrodes 43 may be connected, via switch bank 41, to the input of one of the sense amplifiers, and all column electrodes of electrodes 40 may be connected, via the switches 44, to the input of a second sense amplifier, allowing a parallel operation of the scanning of the row and column electrodes, and the switches 41, 44. In that case, correlator 46 may comprise and additional input for applying the output of the second sense amplifier. The row and column electrodes may also be grouped into other groups such as, in case of e.g. four sense amplifiers, connecting one quarter of the row electrodes and a quarter of the column electrodes to a first one of the sense amplifiers via respective switches, and applying this grouping scheme to the other sense amplifiers in a similar fashion. Using four sense amplifiers provides an increase of the scanning speed by a factor of four.

When the signals from all of the sense electrodes 40, 43 have been received by the correlator 46 or evaluation circuitry, the position of the finger or touching part or tool can be determined, using e.g. an appropriate algorithm such as e.g. a common-centroid algorithm. This determination of the position of the finger or other part or tool can be effected by means of a processor 49 connected to the output of correlator 46. In another embodiment, the correlator or other evaluation function and the processor 49 may be combined to a position detection circuitry. In both cases, the position of the finger, or other body part or tool, can be detected with high precision with high resolution.

In the embodiment of FIGS. 3, 4, the user usually holds the device 30 in one hand, and points to the display 31 using a finger, or other tool, from the other hand.

The device 30 may be any type of e.g. hand-held device such as a phone, a personal digital assistant, a laptop, navigation system, etc.

The signals generated by the BCC transmitter 33, 47 and coupled to the body of the user may additionally comprise, in addition to the digital code or the like, specific signals such as synchronization signals, allowing the correlator/processor to synchronize the BCC transmitter signals coupled to the body with the BCC signals received from the body via the sense electrodes 40, 43, for increasing the precision and quality of correlation detection and position detection and evaluation, by compensating for any potential delay when transmitting the BCC signals via the body and possibly air or intermediate components to the sense electrodes.

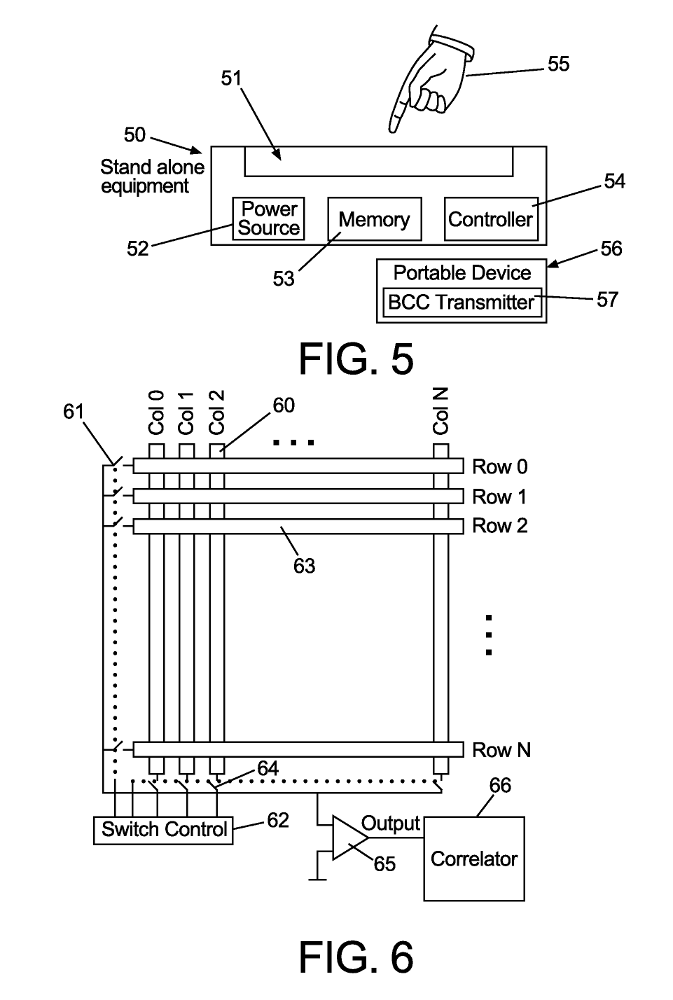

FIGS. 5, 6 illustrate a further embodiment in accordance with the invention, which comprises a hand-held device 50 and a separate portable device 56 which includes a BCC transmitter 57. Apart from the separation of the BCC transmitter 57 from the hand-held device, all other implementation features discussed above with regard to the embodiment of FIGS. 3, 4, may optionally be provided also in the embodiment of FIGS. 5, 6, unless explicitly stated otherwise.

The embodiment shown in FIGS. 5, 6 is implemented as a stand-alone, e.g. not hand-held, equipment. The embodiment may for example be implemented as a monitoring equipment in a hospital or any other type of organization such as factory etc. In the embodiment of FIGS. 5, 6, a user is wearing a BCC transmit device such as device 56 which may for example be a wrist band or device transported in a pocket of the user clothes. The stand-alone equipment 50 comprises a touch-sensitive display 51 which may correspond to touch-sensitive display 31, and may be actuated using a finger 55, or other body part or tool of a user, touching or being in close proximity to the surface of the touch-sensitive display 51. A power source 52 may be integrated into the equipment 50 or may be provided by connection to power lines etc. The equipment 50 may further comprise a memory 53 for storing values for detecting and/or evaluating a position of the finger or other tool pointing to, or touching, the touch-sensitive display 51, and a controller 54 for touch/pointing position detection.

FIG. 6 shows an arrangement of sense electrodes 60, 63 incorporated in the touch-sensitive display 51. The electrodes 60, 63 are connected to switches 61, 64 controllable by a switch control 62 for controllable connection to an input of sense amplifier 65. An output of sense amplifier 65 is connected to a processor 66 for evaluating and detecting a touching or pointing position of finger 55 or other tool. The above explanations given with regard to components 30 to 34, 40 to 49 of FIGS. 3, 4, as well as any discussed options, likewise are valid for the embodiment of FIGS. 5, 6, and components 50, 57, 60, 66, apart from the separated provision of the BCC transmitter 57.

In the embodiment of FIGS. 5, 6, the BCC code transmitted from the separate portable device 56 and BCC transmitter 57 can be detected by the sense electrodes 60, 63 in the display 51.

A BCC code transmitted by the BCC transmitter 47, 57 may be programmed into, or provided in any other form, in the device 30 or stand-alone equipment 50. The equipment 50 may in another embodiment also be implemented so as to generate a BCC code, and to transmit this code to the portable device 56 for storing in this device 56 for use in the BCC transmitter 57. In the embodiment shown in FIG. 5, the BCC code may be stored in memory 53 of equipment 50. The BCC code stored in memory 53 or otherwise memorized or generated in equipment 51 can be used for correlation in the receive electronics of equipment 50, such as controller 54, for correlation with of the received signals sensed by the sense electrodes 60, 63 with the BCC signals generated by the transmitter 57.

The provision of the BCC code may e.g. be achieved in form of a set-up operation in which a code of, or assigned to, the user is input to the portable device 30, 56 and/or the equipment 50 to be controlled by the user carrying the portable device 56.

In one or more embodiments, unique BCC codes may be provided for each of several users and may advantageously be used for identification of the respective user so as to detect which user is actually using equipment 50.

When the user touches, or approaches, the screen of the touch-sensitive display 51, the sense electrodes drive electronics such as processor 66 can search through all of the unique correlation codes or BCC codes for the known set of users so as to detect an actually received BCC code and thus detect a current user. In this manner, the benefit of improved sensitivity is maintained, as in the above described embodiments. In addition, the user can be identified.

The identification of the user may be used e.g. for customization of the user interface, providing e.g. different display information to different users, or alternatively or additionally be used to enable or disable certain functions for different users. For example, in case a function such as a “delete” function is only allowed for one or more of the users such as user A, the function such as “delete” function will be operated in case an authorized user such as user A touches the displayed “delete” button or other function button. If another user such as user B not allowed to execute the respective function such as “delete” function, touches the delete button, the desired function will not be triggered and allowed. The system may also be configured to give an appropriate feedback such as for example dimming the disallowed button when the finger of user B approaches the “delete” button.

Embodiments of the invention may be implemented e.g. in touch displays in handheld devices such as e.g. remote controls, or stationary devices. In addition, or in other embodiments, a personalization of devices can be provided. As an example, in light switches incorporating e.g. equipment 50, the light switch may recognize the user touching or approaching the light switch and may set up an appropriate lighting scene.

One or more touch displays in accordance with embodiments of the present invention may also be used in stand-alone equipment such as in hospitals. The equipment can recognize the user and may also selectively enable/disable certain functions depending on which user is using the equipment. The recognition of the user may also be used for tracking the users, and/or the time of use, which have used the equipment. Embodiments of the invention may also be implemented in, or as, interactive surfaces wherein the surface, or equipment connected to the surface, may be controlled depending on the user touching, or approaching, the interactive surface. As an example, the interactive surface may comprise a sense electrode arrangement as shown in FIGS. 4, 6 incorporated in a touch-sensitive surface which is not implemented as an active display but may for example show only fixed fields with fixed labeling corresponding to different, specially provided function fields for triggering one of several functions when touching a field assigned to that function.

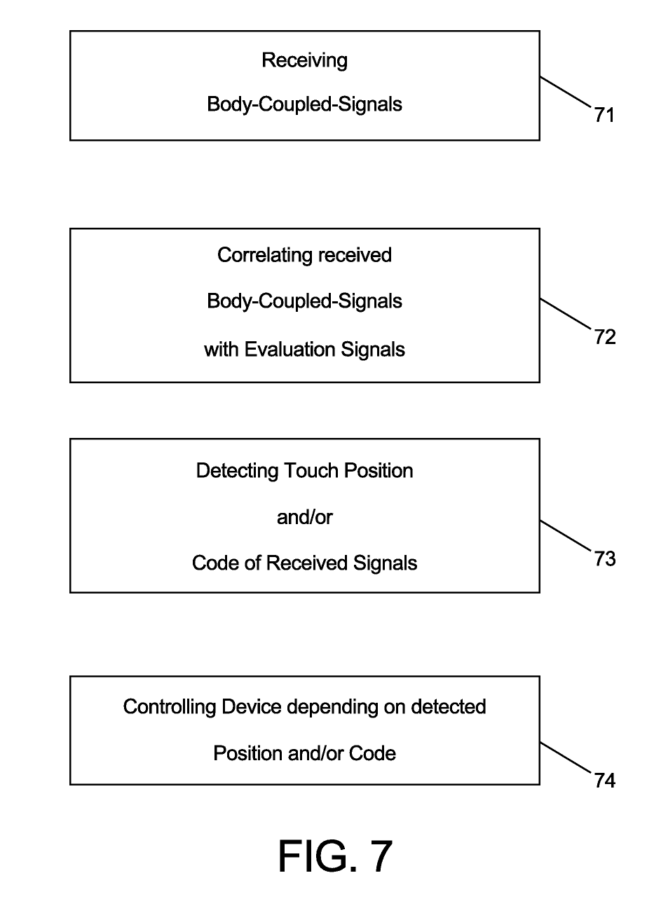

FIG. 7 illustrates an embodiment of a method in accordance with the invention. As shown in block 71, body-coupled signals are received in a receiver such as a touch-sensitive display 31, 51 or an interactive surface. In block 72, received body-coupled signals are evaluated, e.g. by correlating the received signals with expected signals or the signals transmitted from a transmitter to the body. Based on the evaluation of the received signals, a touch or approximating position of a body part such as a human finger, and/or a code of the received signals are detected in block 73. As shown in block 74, a device is controlled depending on the detected location of the touching or approaching part such as a finger, and/or depending on the detected code of the BCC signals.

The BCC touch input may be used with electrodes of any pattern, e.g. a small number of fixed button/finger electrodes. In one or more embodiments as shown, the BCC touch input is used with an X-Y grid of electrodes.

A single processor or other unit or controller may fulfill the functions of one or more or all means recited in the claims and the above description. Features discussed above or shown in the drawings, or recited in separate dependent or independent claims may be advantageously combined in any arbitrary combination.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure and the appended claims. In the description and claims, the word “comprising” does not exclude other elements or steps, and the indefinite article “a” or “an” does not exclude a plurality. A single processor or other unit may fulfil the functions of one, several or all items recited in the claims. Several processors may be provided for fulfilling the functions of several items mentioned above or recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the internet or other wired or wireless telecommunication systems. Any reference signs in the claims should not be construed as limiting the scope. Any of the above disclosed features or functions may be implemented in form of a computer program or software provided in a respective component. As an example, in an embodiment, the correlating function of correlator 46, and/or the evaluation function of processors 49, 66 may be provided in form of routines or software loadable into, or provided in a controller or processor or device section.

1. Device, comprising a touch- or proximity-sensitive interface, the interface comprising
a sensor electrode arrangement configured to receive one or more body-coupled communication signals via a user part touching or approaching the interface, and
a detector configured to detect a position of the user part based on the one or more body-coupled communication signals.

2. Device according to claim 1, wherein the sensor electrode arrangement is a capacitive sensing arrangement incorporated inside the interface.

3. Device according to claim 1, wherein the sensor electrode arrangement comprises a first set of at least two sense electrodes and a second set of at least two sense electrodes, the first set of sense electrodes being angularly arranged to the second set of sense electrodes.

4. Device according to claim 1, comprising at least one of an active plate, a passive plate, and sense electrodes added to at least one of the plates.

5. Device according to claim 1, wherein the sensor electrode arrangement comprises sense electrodes, at least one sense amplifier, and switches for connecting the sense electrodes to the at least one sense amplifier.

6. Device according to claim 1 wherein the interface comprises at least one of a touch sensitive display, a touch screen, a liquid crystal display, a proximity sensitive display, and an interactive surface.

7. Device according to claim 1, comprising a correlator configured to correlate a received body-coupled communication signal received via the user part with a communication signal transmitted to a user body.

8. Device according to claim 1, wherein the receiver is configured to receive a coded signal coupled to a user body.

9. Device according to claim 1, comprising means configured to provide an identification function, the identification function configured to identify a user by means of a coded signal received via the sensor electrode arrangement.

10. Device according to claim 1, comprising means configured to provide a security function, the security function configured to identify a user by means of a coded signal received via the sensor electrode arrangement, the security function being configured to at least one of restrict access to the device depending on the identification result, customize a user interface, enable/disable certain functions for different users, personalize devices such as light switches.

11. Device according to claim 1, comprising a transmitter configured to transmit communication signals to the body of a user of the device, the transmitter being either incorporated into the device, or provided separate from the device.

12. Device according to claim 1 wherein the device is or comprises a liquid crystal display device, a handheld device, a mobile phone, a remote control, or an equipment controller.

13. Method, comprising,
receiving one or more body-coupled communication signals via a sensor electrode arrangement of a touch- or proximity-sensitive interface, and
detecting a position of a user part touching or approaching the interface based on the one or more body-coupled communication signals received via the user part and the sensor electrode arrangement.

14. Computer program product, comprising software code portions for
receiving one or more body-coupled communication signals via a sensor electrode arrangement of a touch- or proximity-sensitive interface, and
detecting a position of a user part touching or approaching the interface based on the one or more body-coupled communication signals received via the user part and the sensor electrode arrangement.

15. Computer program product according to claim 14 wherein the program is stored on a computer-readable medium.
